(19) United States
(12) Patent Application Publication
(10) Pub. No.: US 2026/0085768 A1
(43) Pub. Date: Mar. 26, 2026

(54) VALVE AND VALVE SYSTEM

(71) Applicant: Festo SE & Co. KG, Esslingen (DE)

(72) Inventors: Michael LOOS, Esslingen (DE); Ralf STARZMANN, Reichenbach (DE); Daniel KERSTEN, Esslingen am Neckar (DE)

(21) Appl. No.: 19/333,022

(22) Filed: Sep. 18, 2025

(30) Foreign Application Priority Data
Sep. 23, 2024 (DE) 10 2024 127 349.6

(51) Int. Cl. F16K 37/00; F16K 27/04; F16K 11/07

(52) U.S. Cl. CPC F16K 37/0033; F16K 27/041; F16K 27/048; F16K 11/07

(57) ABSTRACT

A valve for a valve system, with a valve housing and a fluid channel formed in the valve housing, extending between an inlet connection and an outlet connection, in which a valve member is linearly movable along a movement axis between a first functional position and a second functional position. The valve member is provided with a permanent magnet and is coupled in motion to a drive associated with the valve housing. A magnetic field sensor for detecting a position of the valve member is arranged in the valve housing for detecting a position of the valve member, in which a shielding plate is arranged on a side surface of the valve housing at the level of the permanent magnet in order to reduce a magnetic flux density provided by the permanent magnet in a space adjacent to the side surface outside the valve housing.

### CROSS-REFERENCE TO RELATED APPLICATION

This application claims priority to German application no. 102024 127 349.6 filed September 23, 2024, which is incorporated by reference.

### BACKGROUND OF THE INVENTION

The invention relates to a valve and a valve system.

Valves are used to control the flow of working fluids, such as compressed air. The valves each have a fluid channel and a valve member movably arranged in the fluid channel, with which a fluid channel cross-section can be influenced. In this way, when a large fluid channel cross-section is released, a large amount of working fluid can pass through the fluid channel, and when a small fluid channel cross-section is released, a small amount of working fluid can pass through the fluid channel. The valve member also may block the fluid channel to prevent the working fluid from passing through the working channel. The position of the valve member in the fluid channel provides information about the set free fluid channel cross-section, this position can be detected by a position sensor. For this purpose, a magnetic field sensor with a permanent magnet assigned to the valve member are may be provided. Several valves can be combined in a valve system (sometimes also called a valve island) in order to centralize their supply with working fluid and/or their control. The task of the present invention is to improve the accuracy and robustness of the sensory detection of the position of valve members in valves to be arranged in a valve system. The task is solved by a valve with the following features:

### SUMMARY OF THE INVENTION

A valve according to the invention, which is to be used in a valve system has a valve housing and a fluid channel formed in the valve housing, the fluid channel extending between an inlet connection and an outlet connection, in which fluid channel a valve member is mounted so as to be linearly movable along an axis of movement between a first functional position (opening opsition) and a second functional position (closing position), wherein the valve member is provided with a permanent magnet and is motion-coupled to a drive , which drive is associated with the valve housing and may be integrated in the valve housing, and wherein a magnetic field sensor for detecting a position of the valve member is arranged in the valve housing, wherein a shielding plate is arranged on a side surface of the valve housing at the level of, in particular in the close neighborhood to the permanent magnet in order to reduce a magnetic flux density provided by the permanent magnet in a space area outside the valve housing adjacent to the side surface.

The valve housing determines the outer shape of the valve and is manufactured of a plastic material. The fluid channel extends within the valve housing. Working fluid is conducted through the valve housing in the fluid channel. The working fluid, in particular compressed air, enters the fluid channel through the inlet connection and exits the fluid channel through the outlet connection. There may be more than one inlet connection and more than one outlet connection. In particular, a working fluid source is connected to the inlet connection and a fluid consumer, such as a pneumatic drive, in particular a pneumatic cylinder, is connected to the outlet connection.

The valve member is mounted in the fluid channel so that it can move linearly along the axis of movement. The valve member can be used to influence the free fluid channel cross-section in the fluid channel. The channel cross-section can be enlarged and can be reduced depending on the position of the valve member along the axis of movement. The fluid channel cross-section, which is released by the valve member, correlates with the amount of working fluid that can be conveyed through the fluid channel per unit of time at a given fluid pressure. The smaller the fluid channel cross-section, the less working fluid can be conveyed through the fluid channel per unit of time. If the fluid channel is closed, no more working fluid can be conveyed through the fluid channel.

The valve member can be moved between the first functional position and the second functional position. The first functional position and the second functional position differ from each other with respect to the position of the valve member along the movement axis, resulting in in a difference of the fluid channel cross-section. For example, a maximum fluid channel cross-section is related with the first functional position, while the fluid channel is closed in the second functional position. In addition, the drive can be designed to move the valve member into further functional positions which are located between the first functional position and the second functional position. Such a valve is referred to as a proportional valve.

The axis of movement of the valve member can run parallel to a longitudinal axis of the fluid channel or at an angle to it, in particular perpendicular to the longitudinal axis of the fluid channel. A valve seat may be arranged in the fluid channel, wherein the valve member has a sealing section which, in the second functional position, seals against the valve seat or rests on the valve seat. The valve can be designed such that, in the second functional position, an outer circumferential surface of the sealing section rests against the valve seat, which is a part of a bore forming the fluid channel. Such a valve is referred to as a slide valve. Alternatively, the valve can be designed such that, in the second functional position, an end face of the sealing section rests on the valve seat. Such a valve is referred to as a seat valve. A rubber-elastic seal may be fixed to the sealing section. In particular, the sealing section has a groove in which a rubber-elastic sealing ring is accommodated.

In order to detect the position of the valve member in the fluid channel, the valve member is equipped with the permanent magnet and the magnetic field sensor is arranged in the valve housing. The magnetic field sensor is designed to provide an electric sensor signal, which signal depends on the magnetic field formed around the magnetic field sensor. The strength of magnetic field increases when the distance between the permanent magnet and the magnetic field sensor decreases, and conversely, the magnetic field decreases with an increasing distance between the permanent magnet and the magnetic field sensor. Since the permanent magnet is coupled to the valve member, a movement of the valve member or its position in the fluid channel influences the strength of the permanent magnet which can be detected by the magnetic field sensor. In this respect, the position of the valve member in the fluid channel can be determined based on the strength of the magnetic field which is detected by the magnetic field sensor.

A recess protruding into the valve member may be formed in a first head end of the valve member located outside the axis of movement, in which the permanent magnet is accommodated. Alternatively, the permanent magnet can be designed as a ring arranged on an outer circumferential surface of the valve member.

The valve member is motion-coupled to the drive , wherein the drive is associated with the valve housing. Preferably the drive is integrated into the valve housing. Accordingly, the valve member can be moved by means of the drive or the valve member can be moved into different positions in the fluid channel by means of the drive . The drive comprises an electric, electromagnetic or pneumatic actuator. In particular, the drive is a combination of a pneumatic actuator and a pneumatically acting electric pilot valve. The pilot valve is coupled to a pressure chamber in which a first head end of the valve member is sealed and which is hereinafter referred to as the first pressure chamber. If the pilot valve is actuated in such a way that the pressure chamber is filled with working fluid, in particular with compressed air, the volume in the pressure chamber increases so that the valve member is moved outwards, i.e. away from the pressure chamber, along a first direction of movement which runs parallel to the axis of movement.

In order to be able to move the valve member in a second direction of movement opposite to the first axis of movement, a second pressure chamber may be provided, which may be fluidically coupled to a further pilot valve and in which a second head end, arranged opposite to the first head end, is received in a sealing manner. If the valve member is to be moved in the second direction of movement, the second pressure chamber is pressurized by supplying working fluid and, if necessary, the pressure in the first pressure chamber is reduced, for example by venting the first pressure chamber. Instead of two pilot valves, each of which is assigned to a pressure chamber, a single pilot valve may be provided that is assigned to both pressure chambers. With this single pilot valve, the first pressure chamber can be vented while the second pressure chamber is vented, and at the same time the second pressure chamber can be vented while the first pressure chamber is vented. Such a single pilot valve may be designed as a 3/2-way valve. In addition, instead of or in addition to the second pressure chamber, a spring coupled to the second head end and under a preload may be provided, which moves the valve member in the second direction of movement when the first pressure chamber is not pressurized. Furthermore, the valve can be designed as a 5/3-way valve, in which, in particular, in addition to the first pressure chamber and in addition to the second pressure chamber, a spring under pretension is provided in each case, whereby the two springs under pretension preferably move the valve member, when neither of the two pressure chambers is pressurized, into the intermediate position designed as a middle position between the first functional position and the second functional position.

According to the invention, the shielding plate is arranged on a side surface of the valve housing at the level of the permanent magnet. In particular, the shielding plate extends such that a shielding function is provided in both of the functional positions of the valve member. This reduces the magnetic flux density provided by the permanent magnet in the space adjacent to the side surface outside the valve housing. The reduction in magnetic flux density in the area outside the valve housing adjacent to the side surface reduces the influence of the permanent magnet on magnetic field sensors of neighboring valves, which are also to be arranged on the valve system. This improves the accuracy and robustness of the sensory detection of the position of the valve members in the adjacent valves. This is particularly advantageous when the valves are arranged very close together on the valve system, for example with only a few millimeters or fractions of a millimeter between them.

The reduction in flux density is achieved by using the shielding plate to deflect the magnetic field lines of the magnetic field provided or generated by the permanent magnet in such a way that they do not pass through the shielding plate but run within the shielding plate. This prevents the deflected magnetic field lines from entering the valve housing of an adjacent valve and influencing the magnetic field sensor of the adjacent valve. In addition, the shielding plate serves to prevent a magnetic field generated outside the valve housing from penetrating the valve housing and influencing the magnetic field sensor. Such a magnetic field generated outside the valve housing is, in particular, a magnetic field generated by a permanent magnet of an adjacent valve.

The side surface of the valve housing on which the shielding plate is arranged is aligned in particular perpendicular to an alignment direction of the valve system along which alignment direction the valves are arranged next to each other. It may be provided that on each of two opposite side surfaces of the valve housing at the level of the permanent magnet a shielding plate is arranged. This ensures that the magnetic field lines generated by the permanent magnet do not penetrate into a valve located adjacent to one side surface or into a valve located adjacent to the other side surface, and that magnetic field lines do not penetrate into the valve via either side surface.

Advantageous further developments of the invention are the subject of the subclaims.

Preferably, the shielding plate extends beyond the permanent magnet along the axis of movement from the direction of the inlet connection and from the direction of the outlet connection in both the first functional position and the second functional position. Taking into account that the magnetic field is pronounced along each spatial direction, in particular spherically, the magnetic field is not only present in the form of a cylindrical section perpendicular to the axis of movement around the permanent magnet, but also obliquely to and along the axis of movement. The magnetic field, which is present in a horizontal plane spanned by the axis of movement and a normal axis running perpendicular to the side surface and at an angle but not perpendicular to the axis of movement, is at least partially shielded by the fact that the shielding plate protrudes beyond the permanent magnet as described above. In particular, the shielding plate is designed in such a way that at least the part of the magnetic field in the horizontal plane and at an angle but not perpendicular to the axis of movement is shielded by the shielding plate, which could otherwise influence the magnetic field sensor of an adjacent valve.

Preferably, along the axis of movement, the shielding plate extends at least 20%, preferably at least 50%, and particularly preferably at least 100% further than a path section which is traveled by the permanent magnet between the first functional position and the second functional position. This path section is the distance between the position of a first axial end region of the permanent magnet facing the first functional position in the first functional position and the position of a second axial end region of the permanent magnet facing the second functional position in the second functional position. The distance between the first axial end region of the permanent magnet and the second axial end region of the permanent magnet is identical to the length of the permanent magnet in the direction of the movement axis. Accordingly, this path section covers all positions at which the permanent magnet can be located between the first functional position and the second functional position. The path section depends, on the one hand, on the extension of the permanent magnet along the axis of movement and, on the other hand, on the distance between the first functional position and the second functional position. In particular, the path section is the sum of the extension of the permanent magnet along the axis of movement and the distance between the first functional position and the second functional position.

Purely as an example, the extension of the shielding plate along the axis of movement is at least 150% greater than the path section covered by the permanent magnet between the first functional position and the second functional position.

Furthermore, the extension of the shielding plate along the axis of movement is preferably a maximum of 500%, preferably a maximum of 300% and particularly preferably a maximum of 250% greater than the distance covered by the permanent magnet between the first functional position and the second functional position.

Preferably, the extension of the shielding plate along the axis of movement is at least 50%, preferably at least 100%, and particularly preferably at least 200% greater than the extension of the permanent magnet along the axis of movement.

Preferably, the shielding plate extends beyond the permanent magnet along a transverse axis running perpendicular to the axis of movement and parallel to the side surface, in the direction of the magnetic field sensor and in a direction away from the magnetic field sensor.

Preferably, along the transverse axis, an extension of the shielding plate is at least 50%, preferably at least 100%, and particularly preferably at least 250% greater than an extension of the permanent magnet in this direction.

The magnetic field present in a vertical plane spanned by the transverse axis and the normal axis and oblique to the normal axis is at least partially shielded by the fact that the shielding plate along the transverse axis is larger than the corresponding extension of the permanent magnet, as described above. In particular, the shielding plate is designed in such a way that at least the part of the magnetic field present in the vertical plane and oblique to the normal axis is shielded by the shielding plate, which could otherwise influence the magnetic field sensor of an adjacent valve.

Preferably, along the transverse axis, the extension of the shielding plate is at most 1000%, further preferably at most 800%, and particularly preferably at most 600% larger than the extension of the permanent magnet.

Preferably, the shielding plate has a magnetic permeability that is greater than the magnetic permeability of the side surface. The magnetic permeability corresponds to the permeability of matter to magnetic fields, whereby the permeability of matter to magnetic fields increases with increasing magnetic permeability, thereby reducing the resistance opposite to the magnetic field. The course of the magnetic field is influenced by the resistance opposing the magnetic field in such a way that the magnetic field runs where it encounters the least resistance. Accordingly, the magnetic field runs in the areas that have the highest local magnetic permeability. Since the shielding plate has a higher permeability than the side surface on which it is located, the magnetic field generated by the permanent magnet runs mainly through the shielding plate and not through the side surface in the area of the side surface.

The shielding plate is preferably made of steel, in particular ferritic steel and/or martensitic steel. Steel has a high magnetic permeability. Ferritic steel has a higher magnetic permeability than martensitic steel. Martensitic steel has a higher magnetic permeability than austenitic steel. The shielding plate is preferably made of stainless steel. This provides a shielding plate with high corrosion resistance.

The magnetic field sensor is preferably a magnetoresistive sensor or a Hall sensor. This provides a magnetic field sensor with a small volume, allowing the valve housing to be small in size.

Preferably, a respective shielding plate is arranged on two opposite side surfaces of the valve housing at the level of the permanent magnet in order to reduce a magnetic flux density provided by the permanent magnet in a respective space area adjacent to the respective side surface outside the valve housing. The above description of the individual shielding plate applies equally to each of the two shielding plates.

The task is further solved by a valve system with the following features:

A valve system according to the invention has a base plate with supply air ducts, exhaust air ducts, and several interfaces, wherein at least two interfaces each have a valve designed as described above fluidically coupled to the base plate of the valve system, and wherein the valves are arranged in a row, in particular perpendicular to the axis of movement of the valve member, in such a way that their side surfaces are aligned essentially parallel to each other.

### BRIEF DESCRIPTION OF THE DRAWINGS

The invention is explained in more detail below with reference to the accompanying drawing, which show:

FIG. 1 three valves arranged next to each other in an alignment direction,

FIG. 2 a valve in a longitudinal section, and

FIG. 3 the valve shown in FIG. 2 in a cross-section.

### DETAILED DESCRIPTION

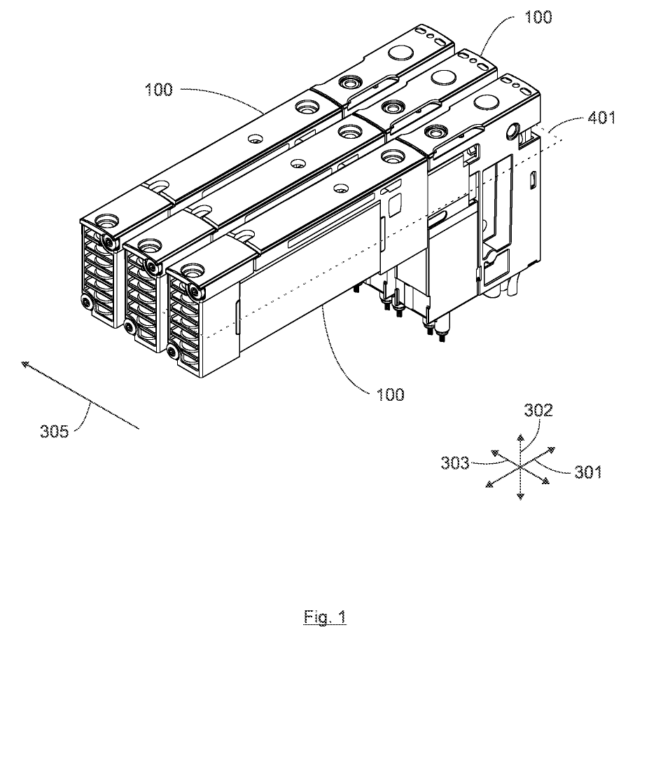

FIG. 1 shows three valves 100 arranged next to each other in an alignment direction 305. The valves 100 each extend along a movement axis 301 which is oriented perpendicular to the alignment direction 305, wherein a normal axis 303 is oriented parallel to the alignment direction 305, and a transverse axis 302 is oriented perpendicular to the movement axis 301 and perpendicular to the normal axis 303.

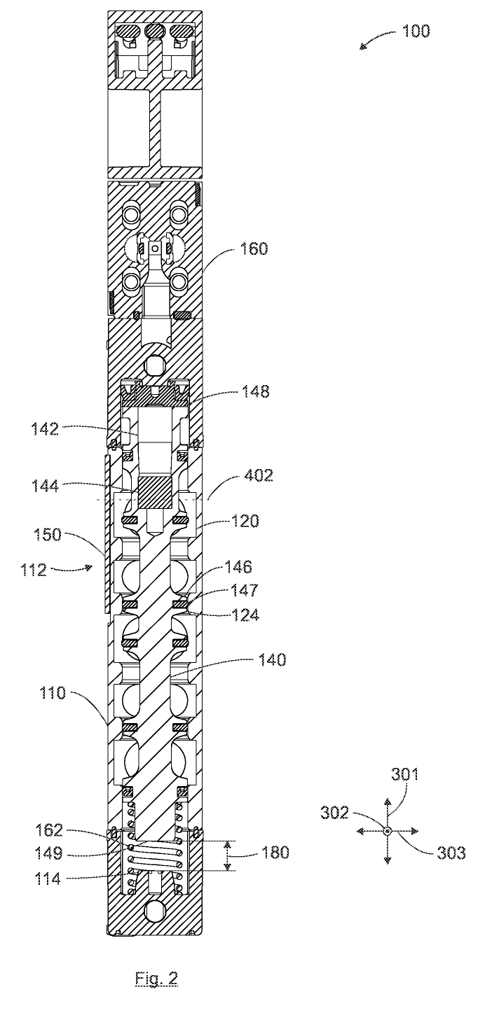

FIG. 2 a longitudinal section of the valve 100 shown at the front in FIG. 1. The longitudinal section according to FIG. 2 is derived from the section plane 401 shown in FIG. 1. The section plane 401 is spanned by the axis of movement 301 and the normal axis 303.

The valve 100 has a valve housing 110. In the valve housing 110, a fluid channel 120 extends between an input connection (not shown) and an output connection (not shown) along the axis of movement 301. A valve member 140 is accommodated in the fluid channel 120. The valve member 140 is received in a linearly movable manner along the axis of movement 301 between a first functional position and a second functional position (not shown). In FIG. 2, the valve member 140 is in the first functional position.

For illustrative purposes only, a stop 114 is formed in the valve housing 110. In the first functional position, the valve member 140 is spaced apart from the stop 114 with a second head end 149 facing the stop 114. In the second functional position, the valve member 140 rests against the stop 114 with the second head end 149. Between the first functional position and the second functional position, there is a stroke 180 over which the valve member 140 can move in the fluid channel 120.

Purely by way of example, the valve 100 has a drive comprising a plunger 148 and a pilot valve 160. The pilot valve 160 and the plunger 148 are arranged on a first end of the valve member 140 facing away from the stop 114. The pilot valve may provide compressed air into a bore, in which the plunger 148 is located, to effect a pneumatic force acting on the plunger 148, which results in a linear movement of the plunger 148 and the valve member 140. In the first functional position shown in FIG. 2, the pilot valve 160 is controlled in such a way that the valve member 140 does not act against a spring 162 arranged at the second head end 149 of the valve member 140. If the pilot valve 160 is controlled in such a way that compressed air is provided to the bore in which the plunger is located, the valve member 140 acts against the spring 162 and overcomes the spring force exerted by the spring 162. As a result the valve member 140 is moved into the second functional position.

The valve member 140 is provided with a permanent magnet 144. Purely by way of example, a recess 142 is formed in the first end region of the valve member 140, in which the permanent magnet 144 is accommodated.

A shielding plate 150 is arranged on a side surface 112 of the valve housing 110 at the level of the permanent magnet 144 in order to reduce a magnetic flux density provided by the permanent magnet 144 in a space area outside the valve housing 110 adjacent to the side surface 112.

Purely by way of example, a valve seat 124 is arranged in the fluid channel 120, wherein the valve member 140 has a sealing section 146 which, in the first functional position, sealingly abuts the valve seat 124. The valve 100 shown in FIG. 2 is designed purely by way of example as a slide valve.

Purely as an example, the valve member 140 has several sealing sections 146 and several valve seats 124 are arranged in the fluid channel 120. For the sake of clarity, only a single sealing section 146 and a single valve seat 124 are provided with a reference symbol in FIG. 2. Purely as an example, in both the first functional position and the second functional position, some sealing sections 146 are in contact with their assigned valve seats 124. Some of the sealing sections 146 that are in contact with their assigned valve seats 124 in the first functional position do not bear against their assigned valve seats 124 in the second functional position, and conversely, some sealing sections 146 that do not bear against their assigned valve seats 124 in the first functional position bear against their assigned valve seats 124 in the second functional position.

Purely by way of example, the valve 110 is designed as a 5/2-way valve, with four sealing sections 146 and four valve seats 124 provided.

Purely by way of example, the shielding plate 150 extends beyond the permanent magnet 144 along the axis of movement 301 in each case from the direction of the inlet connection and from the direction of the outlet connection, i. e. in each case from the direction of the first head end 148 and the second head end 149, in each case in the first functional position and in the second functional position.

Purely by way of example, a rubber-elastic seal 147 is fixed to the sealing section 146. Furthermore, by way of example, the sealing section 146 has a groove, which is not provided with a reference symbol, in which the seal 147, which is designed as a rubber-elastic sealing ring, is accommodated.

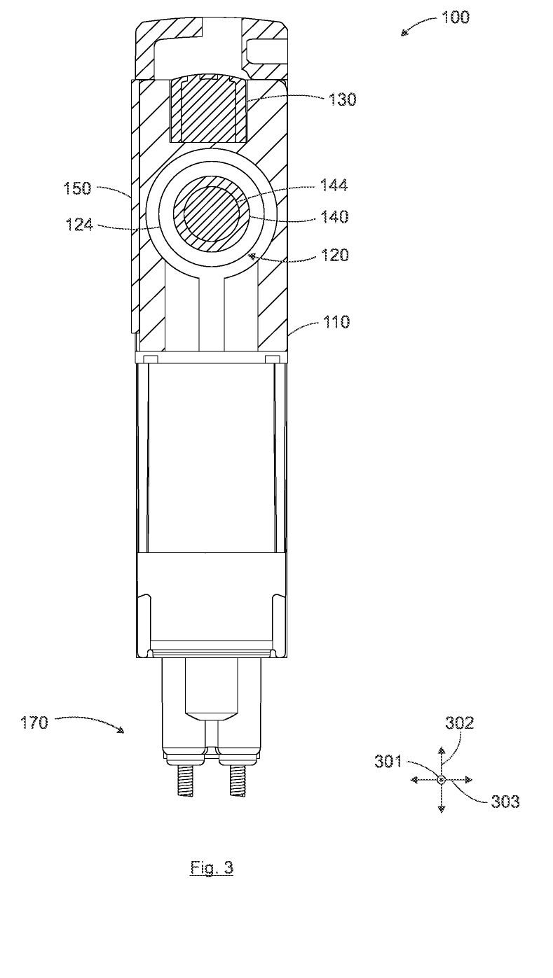

FIG. 3 shows a cross-section of the valve 100 shown in FIG. 2.The cross-section is derived from the sectional plane 402 shown in FIG. 2. The sectional plane 402 is spanned by the transverse axis 302 and the normal axis 303.

A magnetic field sensor 130 for detecting a position of the valve member 140 is arranged in the valve housing 110.

Purely by way of example, the shielding plate 150 extends beyond the permanent magnet 144 along the transverse axis 302 in the direction of the magnetic field sensor 130 and in a direction away from the magnetic field sensor 130.

Purely by way of example, the valve 100 has a coupling section 170 by means of which the valve 100 can be coupled to an interface of a valve system (not shown).

1. A valve for a valve system, with a valve housing and a fluid channel formed in the valve housing and extending between an inlet connection and an outlet connection, in which a valve member is linearly movable along a movement axis between a first functional position and a second functional position, wherein the valve member is provided with a permanent magnet and is motion-coupled to a drive associated with the valve housing, and wherein a magnetic field sensor for detecting a position of the valve member is arranged in the valve housing, wherein a shielding plate is arranged on a side surface of the valve housing at the level of the permanent magnet in order to reduce a magnetic flux density provided by the permanent magnet in a space area outside the valve housing adjacent to the side surface.

2. The valve according to claim 1, wherein the shielding plate protrudes beyond the permanent magnet along the axis of movement from the direction of the inlet connection and from the direction of the outlet connection in both the first functional position and the second functional position.

3. The valve according to claim 2, wherein, along the axis of movement, an extension of the shielding plate is at least 20% greater than a path section, which is a distance traveled by the permanent magnet between the first functional position and the second functional position.

4. The valve according to claim 1, wherein, along a transverse axis extending perpendicular to the axis of movement and parallel to the side surface, an extension of the shielding plate is at least 50% greater than an extension of the permanent magnet.

5. The valve according to claim 1, wherein the shielding plate has a magnetic permeability that is greater than the magnetic permeability of the side surface of the valve housing.

6. The valve according to claim 1, wherein the shielding plate is made of steel, in particular ferritic steel and/or martensitic steel.

7. The valve according to claim 1, wherein the magnetic field sensor is a magnetoresistive sensor or a Hall sensor.

8. A valve system with a base plate that has supply air ducts, exhaust air ducts, and several interfaces, wherein at least two of the interfaces are equipped with a valve, the valve comprising a valve housing and a fluid channel formed in the valve housing and extending between an inlet connection and an outlet connection, in which a valve member is linearly movable along a movement axis between a first functional position and a second functional position, wherein the valve member is provided with a permanent magnet and is motion-coupled to a drive associated with the valve housing, and wherein a magnetic field sensor for detecting a position of the valve member is arranged in the valve housing, wherein a shielding plate is arranged on a side surface of the valve housing at the level of the permanent magnet in order to reduce a magnetic flux density provided by the permanent magnet in a space area outside the valve housing adjacent to the side surface, wherein the valves are fluidically coupled to the valve system, and wherein the valves are arranged next to each other in an alignment direction running perpendicular to the axis of movement in such a way that their side surfaces are aligned essentially plane-parallel to each other.
